(19) United States
(12) Patent Application Publication
(10) Pub. No.: US 2004/0233354 A1
(43) Pub. Date: Nov. 25, 2004

(54) Liquid crystal display element and method of producing the same

(76) Inventors: Shin-ichi Uehara, Tokyo (JP); Ken Sumiyoshi, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 10/476,792

(22) PCT Filed: May 7, 2002
(86) PCT No.: PCT/JP02/04430

(30) Foreign Application Priority Data
May 7, 2001 (JP) 2001-136430

(51) Int. Cl. G02F 1/1335

(52) U.S. Cl. 349/113; 349/95

(57) ABSTRACT

A liquid crystal display element comprising a pair of opposed substrates disposed close to each other, a liquid crystal layer filled in the clearance therebetween, and a backlight. Installed on the substrate associated with the backlight are a reflector plate having an opening, and a condensing means. Bright and quality display can be effected at the time of transmission display and at the time of reflection display.

### TECHNICAL FIELD

The present invention relates to a liquid crystal display element capable of making a bright, quality display both in transmissive display and in reflective display, in the liquid crystal display element of a transmission-reflection changeover type, and to a method for manufacturing the same.

### BACKGROUND ART

Recently, the display element using a liquid crystal is becoming important from the merits of small size, small thickness, light weight and low consumption power The liquid crystal element presently in the mainstream is of the transmissive type having a backlight in the backside of the display element, to utilize the backlight as a light source. However, there is a late tendency of gradually adopting, on portable apparatuses, the reflective type liquid crystal display elements capable of further reducing consumption power, size, weight and cost by using external light.

However, these reflective-type liquid crystal display elements, despite excellent in viewability in a well-lighted place, cannot secure sufficient external light thus having a defect that there is difficulty in discriminating display in a dark place. For this reason, there is a proposal of a front-light system that a light is provided on the display side of the reflective-type liquid crystal display element so that external light is supplemented by putting on the light in the dark place. However, the front-light system involves the defect that display is obscured by interfacial reflection.

Meanwhile, development is made of a liquid crystal display element having a fine opening and backlight in a reflector plate, to effect display through changing over between reflection and transmission. However, in order to make transmissive display brighter, it is required to increase the area ratio of the opening provided in the reflector plate, resulting in a problem of darkened reflective display because of the decreased reflector plate area. Consequently, JP-A-2000-039612 shows a method that a spherical substance having a high refractive index is buried within the fine opening provided in the reflector plate.

According to these methods, it is considered possible to improve the brightness of transmissive display because of the capability of increasing the amount of light substantially transmitting through the opening. Meanwhile, by designing the reflector plate with a great area, the brightness of reflective display can be improved.

Further, JP-A-2000-298267 states a system that, in a reflection-transmission changeover type liquid crystal display element having a backlight, an opening as a vacant hole is provided in a reflection layer thereby arranging a micro-lens between the reflection layer and the backlight layer. By this system, bright display is considered possible both upon transmission and reflection.

In the foregoing, attempts have been actively made recently in order to make compatible both bright transmissive display and reflective display.

As described above, the method for collecting the light from the backlight to the opening provided in the reflector plate is considered effective in improving the brightness of transmission display and reflective display.

However, in the art described in JP-A-2000-039612, the reflector plate having an opening is arranged further outward of a polarizer plate bonded outward the substrate of the liquid crystal display element. This structure causes such a problem of double viewing of display because substrate thickness have an effect of a parallax particularly during reflective display, thus being not preferred in respect of display quality. Meanwhile, since a high refractive-index substance is provided in the fine opening provided in the reflector plate, the distance between the refractive-index substance layer and the reflector plate is impossible to optimize.

By contrast, the backlight for the general liquid crystal display element is designed to emit spreading light in order to secure a constant viewing angle. Such diffused light cannot be fully collected only by the high refractive-index substance layer merely arranged in the opening of the reflector plate. Therefore, it becomes difficult to realize sufficiently bright transmissive display.

Moreover, the exterior reflector plate requires to be bonded after bonding a polarizer plate. Therefore, alignment Is difficult to carry out with high accuracy. Consequently, there is a problem of lowered characteristics of transmissive/reflective display. In this manner, according to the art of JP-A-2000-039612, it is practically difficult to make compatible sufficiently bright, quality transmissive display and reflective display. In order to actually obtain a satisfactory characteristic, there is a need for the methods of internally arranging the reflector plate, optimizing the distance between the high refractive-index substance layer and the reflector plate, and improving the alignment accuracy between the reflector plate and the pixels.

From these reasons, JP-A-2000-298267 for example shows the technique of internally arranging the reflector plate and improving the alignment accuracy between the reflector plate and the pixels. Since the reflector plate is provided on a transparent electrode, parallax caused upon the exterior reflector plate does not occur. As a consequence, it is possible to improve display quality.

Further, the opening is formed by etching a reflector plate provided on the transparent electrode. Therefore, alignment is possible with higher accuracy than the technique with bonding in the later process. However, since the micro-lens sheet used as light-collecting means for the backlight exists exterior, accurate alignment is difficult upon bonding. In addition, since an array board is disposed between the micro-lens sheet and the reflector plate, there is a defect that the thickness of the array board has an effect thereby making it impossible to sufficiently optimize light collection.

In view of the above problem, it is an object of the present invention to provide a novel liquid crystal display element which is capable of making a bright, quality display during transmissive display and upon reflective display and a method for manufacturing the same.

### DISCLOSURE OF THE INVENTION

According to the present invention, in a liquid crystal display element having a pair of substrate arranged closely oppositely, a liquid crystal layer filled in a gap thereof and a backlight, the liquid crystal display element Is provided a reflector plate having an opening and a micro-lens at a liquid-crystal side on the substrate arranged at a backlight side.

According to the present structure, the reflector plate and the micro-lens are arranged on the same side of the substrate and at a liquid-crystal side. Therefore, it is possible to internally arrange the reflector plate, to optimize the distance between the micro-lens and the reflector plate and to improve the alignment accuracy between the opening of the reflector plate and the micro-lens.

When a micro-lens is formed at a liquid-crystal side of one substrate, in the case of using wet etching as a forming method, an etching mask can be produced by the use of a photolithography technique. Thereafter, when a reflector plate is formed, an opening can be formed by using the photolithography technique. Therefore, alignment can be improved in accuracy.

Further, by forming an overcoat layer or bonding a cover glass on the micro-lens before forming a reflector plate, it is possible to optimize the distance between the micro-lens and the reflector plate. The effect of optimization is greatly advantageous particularly in the case of using a backlight to emit diffused light. Accordingly, it is possible to make a bright, quality display with any of transmission and reflection. Moreover, the reflector plate and the micro-lens are internally arranged. Consequently, size/weight reduction is possible.

In place of the micro-lens, the method of forming a vertical type waveguide is also effective. According to the present structure, the light of the backlight incident vertically on a substrate plane is efficiently collected to the opening of the reflector plate by the vertical type waveguide, resulting in bright transmissive display. This can make small the opening of the reflector plate, and therefore, reflective display can be made bright. As compared to the case using the micro-lens, the dependence on the light distribution characteristic of the backlight is comparatively small. Particularly, in the case of diffused light, light collection is advantageously possible with higher efficiency than the case using a micro-lens.

The vertical type waveguide, although formed on the liquid-crystal side of one substrate, can be formed by using the similar forming method to the micro-lens. The shape of the vertical type waveguide is preferably set with a taper angle such that the light of the backlight is collected from the incident side to the exit side. It is also possible to Improve the efficiency by providing a metal film at the interface of the waveguide.

Further, it is also possible to form a horizontal type waveguide instead of the vertical type waveguide In this case, the light of the backlight incident on the substrate plane in parallel therewith is efficiently collected to the opening of the reflector plate by the horizontal type waveguide. Therefore, bright transmissive display is carried out. Thereby, the opening of the reflector plate can be reduced, and consequently, reflective display can become bright. Moreover, a metal film is disposed at the waveguide interface, and thereby, the external light incident to the opening of the reflector plate is reflected by the waveguide metal reflection film. As a consequence, the brightness during reflective display can be maximized. Also, application is possible where the substrate is not transparent.

Although the horizontal waveguide is formed on the liquid-crystal side on one substrate, the forming method is comparatively easy as compared to the case of a micro-lens or vertical type waveguide, allowing for manufacture at low cost. Although merely applying and forming a high refractive-index material on the substrate can provide a waveguide, actually the incident light not satisfying a total-reflection condition leaks from the waveguide, thus lowering the efficiency. Accordingly, it is preferred to form a metal film at the interface of the waveguide.

In the case that a metal film is formed, the material to be applied to the substrate plane is regardless of a refractive index. Therefore, materials can be widely and advantageously selected. In the metal film plane at the waveguide interface on a reflector-plate side, opening is provided so as to be matched to the opening of the reflector plate, from which incident light is to be taken in/out.

It is noted here that a micro-lens may be arranged on an incident side or an exit side of the vertical type or horizontal type waveguide. By an arrangement on the incident side, efficiency can be increased for the light incident to the waveguide. By an arrangement on the exit side, the light exited from the waveguide can be guided with higher efficiency to the opening of the reflector plate.

Moreover, in place of the micro-lens, a hologram can be provided to collect light. The light-collecting pattern of the hologram is preferably designed to efficiently collect the light of the backlight to the opening of the reflector plate. The sheet recorded with a hologram pattern thus designed may be bonded to one substrate at its liquid-crystal side. However, if an unrecorded sheet is previously bonded, and thereafter, a hologram pattern is recorded therein, accurate alignment can preferably be realized. Since manufacture can be easy in respect of the capability of collecting light without using means such as etching, realization is possible comparatively at low cost.

With the above-mentioned structure, it is possible to provide a liquid crystal display element capable of making a bright, quality display during transmissive display and during reflective display, and a method for manufacturing the same.

### BRIEF DESCRIPTION OF THE DRAWINGS

FIG. 1 is a sectional view of a first embodiment of the present invention.

FIG. 2 is a concept view in the case that the light distribution characteristic of a backlight is a diffused light in the first embodiment of FIG. 1.

FIG. 3 is a concept view in the case that the backlight is a spot light source in the first embodiment of FIG. 1.

FIG. 4 is a sectional view showing a second embodiment.

FIG. 5 is a concept view in the case that a micro-lens is provided on an incident side in the second embodiment.

FIG. 6 is a sectional view showing a third embodiment.

FIG. 7 is a sectional view in the case that a projection is provided in the third embodiment.

FIG. 8 is a sectional view showing a fourth embodiment.

### BEST MODE FOR CARRYING OUT THE INVENTION

In an embodiment of a liquid crystal display element according to the preset invention, a liquid crystal display element having a pair of substrates arranged closely oppositely, a liquid-crystal layer filled in a gap thereof and a backlight, a reflector plate having an opening and light collecting means are disposed on the substrate arranged on a backlight side. Hereinafter, the embodiment of the liquid crystal display element of the present invention will be explained with using the drawings.

### FIRST EMBODIMENT

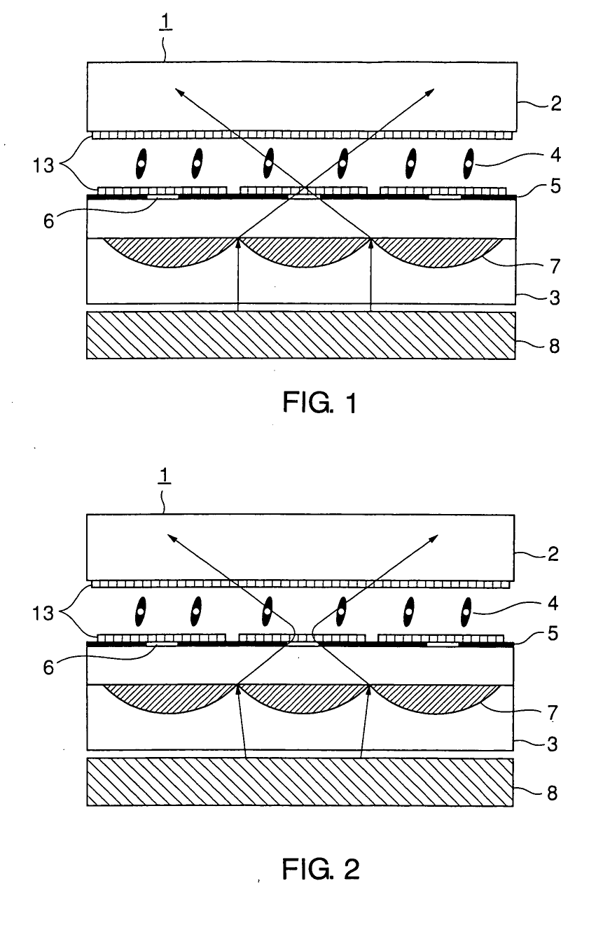

FIG. 1 is a sectional view showing a first embodiment of the present invention. The liquid crystal display element of the present invention comprises a pair of substrates 2, 3 arranged closely oppositely, a liquid-crystal layer 4 filled in a gap thereof and a backlight 8. With this structure, a micro-lens 7 and a reflector plate 5 having an opening 6 are disposed on a liquid-crystal side of the substrate 3 close to the backlight 8.

Of the one pair of substrates 2, 3 of the liquid crystal display element 1, the upper substrate 2 is positioned on a side where external light is to enter while the lower substrate 3 at a liquid-crystal layer 4 side is formed with a reflector plate 5 for reflecting external light. This reflector plate 5 is provided with an opening 6 for allowing transmission light to pass during transmissive display. Further, a transparent electrode 13 for driving the liquid-crystal layer 4 is provided. Moreover, a micro-lens 7 is formed underneath the reflector plate 5 on the liquid-crystal layer 4 side of the lower substrate 3. A backlight 8 is provided on the outer side of the lower substrate 3.

As the lower substrate 3, use can be made of a transparent glass substrate or a plastic substrate. In the case to form a micro-lens on the lower substrate 3 by using a wet-etching method, a metal film such as chromium is formed on the lower substrate and a fine opening is provided in the metal film by using photolithography. An etching solution for the substrate is used to conduct isotropic etching from the fine opening, to thereby form a cavity in a lens form.

This cavity is buried with a high refractive-index material in order to form a micro-lens. The focal length of the micro-lens is determined by a cavity shape and a difference in reflective index between the lower substrate and the high refractive-index material. After burying the high refractive-index material, a reflector plate is formed to form an opening 6 by using a technology of photolithography or the like. The opening 6 is preferably formed in a position where there is much light collected by the micro-lens 7, which usually is preferably aligned with the optical axis of the micro-lens 7.

The position of the reflector light 5 is preferably provided in a part nearly corresponding to the focal length of the micro-lens 7. In the case that it is difficult to form a thickness corresponding to the focal length only by the high refractive-index material, the method of separately applying an overcoat material to the micro-lens 7 or means for bonding a cover glass are also effective. Pixel electrodes (not shown) are formed on the lower substrate 3 and the upper substrate 2, and panel assembling is carried out to thereby form a liquid crystal display element. Finally, although a backlight 8 is arranged at the outer side of the lower substrate 3, the light distribution characteristic of the backlight 8 is an important factor for determining the light collecting efficiency of the micro-lens. In the case that the backlight distribution characteristic is approximate to collimated light and the lens focal length can be reduced, it is preferred to reduce the distance between the micro-lens and the reflector plate.

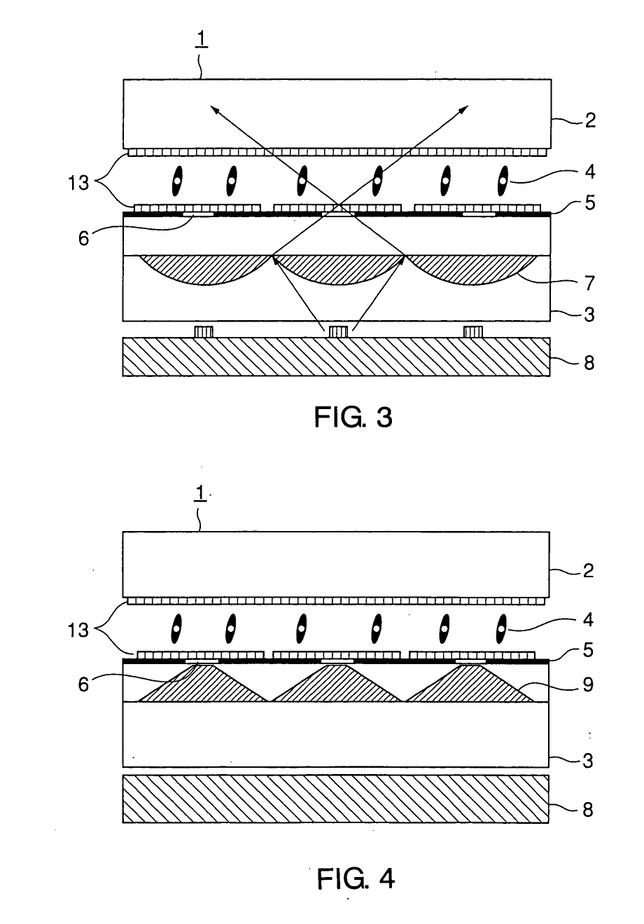

In the case that the backlight distribution characteristic is of diffused light and the lens focal length is great, it is preferred to provide the distance between the micro-lens and the reflector plate greater than the case with collimated light. The concept view in the case the backlight light-distribution characteristic is of diffused light is shown in FIG. 2. By approximating the backlight distribution characteristic toward a spot light source, light collection is possible at higher efficiency. As the spot light source, use can be made of an EL or LED. The concept view, in which the spot light source is used as the backlight, is shown in FIG. 3.

When forming the micro-lens 7, it is possible to use the isotropic etching method using dry etching in place of the wet etching method, the mold method for forming a lens form by embossing a resin, the thermal deforming method for shaping a patterned photosensitive resin into a lens form by heat, the gray-mask method for forming a lens form by using gray-mask multi-tone exposure, the ion diffusion method for changing the refractive index by ion diffusion, the laser irradiating method for providing the refractive index of substrate with an in-plane distribution by laser irradiation, and so on.

The anisotropic etching method, the thermal deforming method and the gray-mask method are advantageous in respect of the capability of determining a lens position by photolithography, similarly to the isotropic etching method. Although the mold method is advantageous in respect of the capability of comparatively easily producing a replica by once making a mold, it is important to increase the accuracy of mold and alignment. The ion diffusion method and the laser irradiation method have a feature that a planar-formed lens is easily obtained. These methods can be used singly or in combination. In the wet etching method, although a cavity is made to fill a high refractive-index material, the method is possible that conversely a convex form is previously made to apply a low refractive-index material.

As the high refractive-index material or low refractive-index material, an organic resin or an inorganic material can be used. Further, the micro-lens can be realized by a Fresnel lens. The Fresnel lens is advantageous in respect of the capability of reducing even the amount of concavo-convex.

In this embodiment, upon performing a transmissive display, the light emitted from the backlight enters the micro-lens 7 after passing through the lower substrate 3. The light entered the micro-lens 7 is collected to the opening 6 provided in the reflector plate 5 and modulated by the liquid-crystal layer 4, and then emits from the liquid crystal display element.

In this event, the position of the opening 6 of the reflector plate of the micro-lens 7 can be set at high accuracy, and therefore, the light transmitting the opening 6 can be maximized. Accordingly, the margin of positional deviation between the micro-lens 7 and the opening 6 can be suppressed to the minimum extent, and consequently, the opening can be made smaller. As a result, the area of the reflector plate 5 can be made greater. This can increase the brightness of reflective display.

Moreover, even when the backlight emits diffused light, the micro-lens and the reflector plate are optimized in position, and therefore, the opening can be made smaller and brightness can be increased in both transmissive display and reflective display.

Further, in the present structure, the reflector plate 5 is provided on the liquid-crystal layer side of the lower substrate 3. Therefore, it is possible to suppress the double images caused by substrate thickness or the like, enabling to obtain quality display.

In addition, since the reflector plate 5 and the micro-lens 7 are internally arranged, thickness/weight reduction is possible also.

### SECOND EMBODIMENT

FIG. 4 is a sectional view showing a second embodiment of the present invention. In the second embodiment, a vertical type waveguide 9 is formed instead of the micro-lens of the first embodiment. In the present structure, the light from a backlight 8 is incident on the vertical type waveguide 9 and collected to an opening 6 provided in a reflector plate 5.

Similarly to the first embodiment, bright quality display is obtained in both transmissive display and reflective display. Besides, in the case that the light of the backlight 8 is of diffused light, light collection is possible at higher efficiency than the case using a micro-lens, making it possible to increase the brightness of transmissive display brighter.

The vertical type waveguide 9 can be made by utilizing the manufacturing method for a micro-lens 7 described in the first embodiment. A taper form is preferable such that light is gradually collected at an incident side to an exit side, and therefore, using the mold method or the gray mask method is particularly preferred. However, it is possible to utilize the wet etching method, the thermal deforming method, the ion diffusion method, the laser irradiation method or the like

A micro-lens 7 may be provided on the incident side or the exit side of the vertical type waveguide 9. By the provision on the incident side, the light to enter the vertical type waveguide 9 can be improved in efficiency. By the provision on the exit side, the light exiting from the vertical type waveguide 9 can be efficiently guided to the opening 6 of the reflector plate 5.

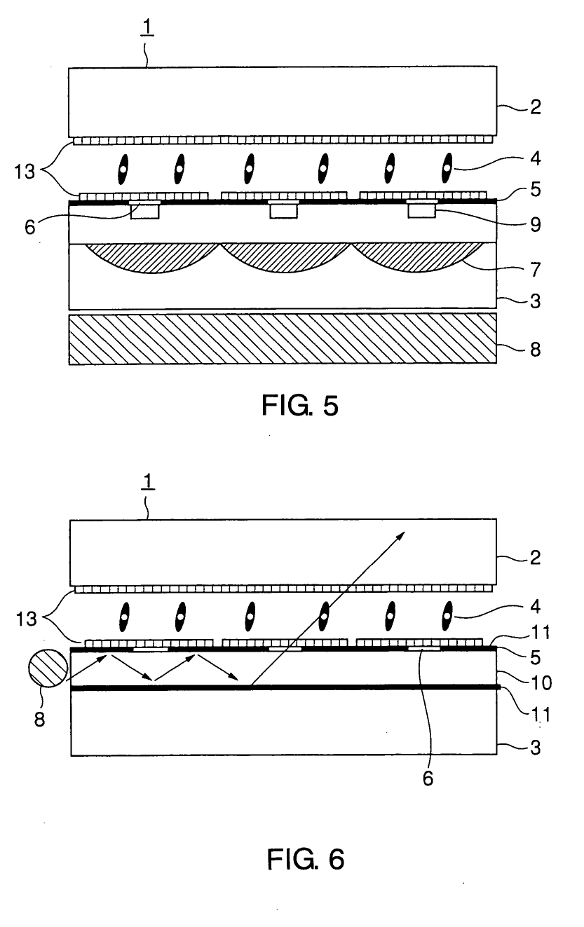

Particularly, in case where a micro-lens 7 is provided on the incident side of the vertical type waveguide 9, there is not necessarily a need to provide a taper on the vertical type waveguide 9, therefore making it possible to utilize the dry etching method during forming. In FIG. 5 is shown a concept view in the case a micro-lens 7 is provided on the incident side of the vertical type waveguide 9.

In the first and second embodiments, it is desirable that the backlight 8 preferably has its light-emitting part patterned in the plane and the pattern is in an arrangement corresponding to the micro-lens 7. In this case, the light-emitting area of the backlight 8 is preferably smaller than a light-collecting area of the micro-lens 7.

### THIRD EMBODIMENT

FIG. 6 is a sectional view showing a third embodiment of the present invention. In the third embodiment, a horizontal type waveguide 10 is formed in place of the vertical type waveguide 9 of the third embodiment. In this structure, the light of a backlight 8 entering in parallel with a substrate plane is incident on the horizontal type waveguide 10 and exits therefrom at an opening 6 provided in a reflector plate 5. In also this embodiment, bright quality display can be obtained in both transmissive display and reflective display similarly to the first and second embodiment. Further, by providing metal films 11, 11 at the interfaces of the horizontal type waveguide 10, the external light incident on the opening 6 of a reflector plate 5 can be reflected. Hence, the brightness during reflective display can be maximized. Also, besides application is possible also to the case that the lower substrate 3 is not transparent, the backlight 8 can be arranged on a side surface of the liquid crystal display element. As a consequence, the liquid crystal display element can be made in a smaller-thickness type.

The horizontal type waveguide 10 can be realized by applying and forming a higher refractive-index material than the substrate on the lower substrate 3 and providing the reflector plate 5 and forming an opening 6 Therefore, it can be made simpler as compared to the first and second embodiments As a result, the liquid crystal display element can be reduced in cost.

It is noted that, in the case to maximize the brightness of reflective display as in the foregoing, it is preferred to apply and form a material after providing a metal film 11 on the lower substrate 3. In case where a metal film 11 is provided, the incident light totally reflects upon a metal-film interface. Since the material is regardless of its refractive index, there is an advantage also with respect to cost.

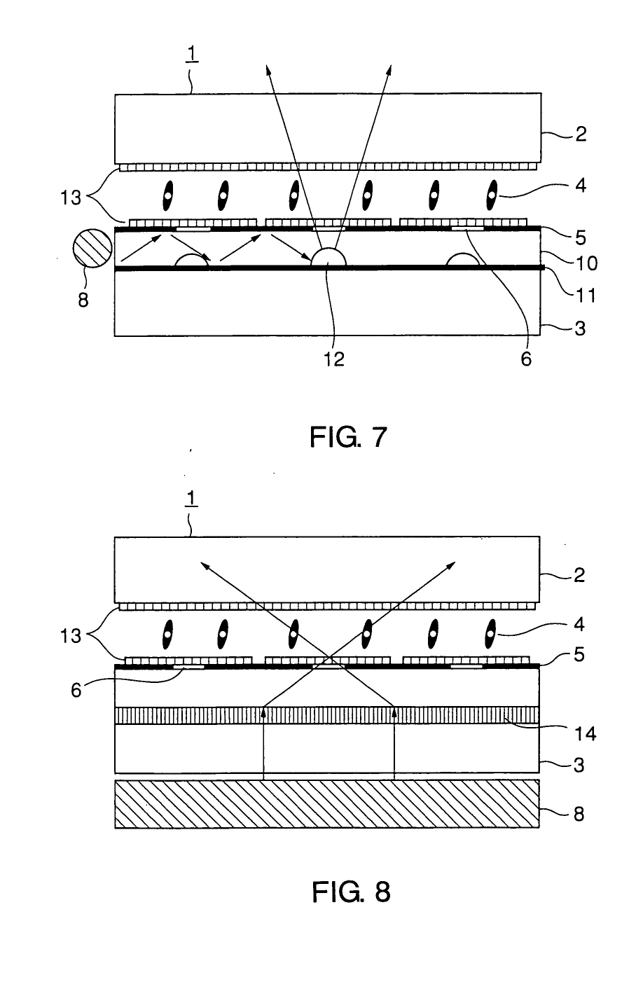

Further, by providing a projection 12 beneath the opening 6 in the reflector plate 5 of the horizontal type waveguide 10 as shown in FIG. 7, light can be efficiently extracted at the opening 6 of the reflector plate. The projection, although can be formed by using a transparent material or the like on the lower metal film 11 of waveguide is effective if provided under the lower metal film 11. In the case of forming on the lower metal film 11, realization is easily possible by photolithography means using a photosensitive transparent material. In the case of forming under the lower metal film 11, it is possible to use means for processing the substrate itself by etching or the like.

### FOURTH EMBODIMENT

FIG. 8 is a sectional view showing a fourth embodiment of the present invention. The fourth embodiment is different in that a hologram 14 is formed in place of the micro-lens of the first embodiment. In the fourth embodiment, the light from a backlight 8 is incident on the hologram 14 and collected to an opening 6 provided in a reflector plate 5. Similarly to the first embodiment, bright quality display is obtained in both transmissive display and reflective display. Besides, in the case that the light of the backlight 8 is of diffused light, the use of a hologram suitable for collecting diffused light enables light collection at higher efficiency than the case using a micro-lens, making it possible to increase the brightness of transmissive display brighter.

The hologram 14 can be realized by bonding a sheet recorded with such a hologram pattern for collecting the light of the backlight 8 to the opening 6 provided in the reflector plate 5, on the lower substrate 13 at its liquid-crystal side Alternatively, it is possible to previously bond an unrecorded sheet and thereafter record a hologram pattern. The latter is preferred because accurate alignment can be realized. Further, a photosensitive resin such as photoresist can be used in place of the hologram-recording sheet. Since manufacture is easy in respect of the capability of collecting light without the use of means such as etching, realization is possible comparatively at low cost.

It is noted, in the first to fourth embodiments of the present invention, a plurality of openings and micro-lenses or waveguides or holograms can be provided on one pixel. Particularly, in the first to fourth embodiments of the present invention, this is preferable because freedom is improved in the design of micro-lens, vertical type waveguide and hologram. Moreover, it is the frequent case that, in the usual liquid crystal display element, three pixels in red, green and blue constitute one set to configure one pixel. In this case, one pixel is elongate. Accordingly, providing a plurality of openings in one pixel is effective in combination with a square micro-lens.

Further, in the second or third embodiment of the present invention, in case where active elements such as TFTs are used together, the stray light to be incident on the TFT can be fully blocked unless a light-shielding film is not provided on the TFT incident side.

Industrial Applicability

The liquid crystal display element according to the present invention, because structured as in the above, can make a bright, quality display both in transmissive display and in reflective display.

1. A liquid crystal display element having a pair of substrates arranged closely oppositely, a liquid crystal layer filled in a gap thereof and a backlight, comprising:
a reflector plate having an opening and light-collecting means, on the substrate arranged on a backlight side.

2. A liquid crystal display element according to claim 1, wherein.
the light-collecting means comprises a micro-lens.

3. A liquid crystal display element according to claim 1, wherein:
the light-collecting means comprises a vertical type waveguide.

4. A liquid crystal display element according to claim 1, wherein:
the light-collecting means comprises a horizontal type waveguide.

5. A liquid crystal display element according to claim 1, wherein:
the light-collecting means comprises a hologram.

6. A liquid crystal display element according to claim 2, wherein:
the micro-lens is structured by a Fresnel lens.

7. A liquid crystal display element according to claim 3, wherein:
a metal film is formed in a waveguide interfacial plane of the vertical type waveguide.

8. A liquid crystal display element according to claim 4, wherein:
a metal film is formed in a waveguide interfacial plane of the horizontal type waveguide.

9. A liquid crystal display element according to claim 3, wherein:
a micro-lens is provided on a light incident plane or a light exit plane of the vertical type waveguide.

10. A liquid crystal display element according to claim 4, wherein:
a micro-lens is provided on a light incident plane or a light exit plane of the horizontal type waveguide.

11. A liquid crystal display element according to claim 1, wherein:
an overcoat layer or a cover glass layer is provided between the light-collecting means and the reflector plate.

12. A liquid crystal display element according to claim 4, wherein:
a projection is provided beneath a reflector plate opening of the horizontal type waveguide.

13. A liquid crystal display element according to claim 8, wherein:
a projection is provided beneath a reflector plate opening of the horizontal type waveguide.

14. A liquid crystal display element according to claim 10, wherein:
a projection is provided beneath a reflector plate opening of the horizontal type waveguide.

15. A liquid crystal display element according to claim 1, wherein:
the backlight at a light-emitting part thereof is patterned on a plane, and
the pattern is in an arrangement corresponding to the light-collecting means.

16. A liquid crystal display element according to claim 15, wherein:
the backlight has a light-emitting area smaller than an area of the light-collecting means.

17. A method for manufacturing a liquid crystal display element comprising a pair of substrates arranged closely oppositely, a liquid crystal layer filled in a gap thereof, a backlight a reflector plate having an opening provided on the substrate arranged on a backlight side, and light-collecting means, wherein:
the light-collecting means is manufactured by any one of an anisotropic etching method or an isotropic etching method or a mold method or a thermal deforming method or a gray mask method or an ion diffusing method or a laser irradiating method.

18. A method for manufacturing a liquid crystal display element comprising a pair of substrates arranged closely oppositely, a liquid crystal layer filled in a gap thereof, a backlight, a reflector plate having an opening provided on the substrate arranged on a backlight side, and light-collecting means, wherein:
the light-collecting means is manufactured by using photolithography, and
the opening of the reflector plate is formed by photolithography
